(19) United States
(12) Patent Application Publication
(10) Pub. No.: US 2026/0166786 A1
(43) Pub. Date: Jun. 18, 2026

(54) SELECTIVE DENSIFICATION OF EXPANDED POLYETHYLENE

(71) Applicant: W. L. Gore & Associates, Inc., Newark, DE (US)

(72) Inventors: Edward H. Cully, Clarksville, VA (US); Jeffrey B. Duncan, Flagstaff, AZ (US); Thomas R. McDaniel, Flagstaff, AZ (US)

(21) Appl. No.: 19/139,681

(22) PCT Filed: Dec. 15, 2023
(86) PCT No.: PCT/US2023/084323

§ 371 Date: Jun. 16, 2025

Related U.S. Application Data
(60) Provisional application No. 63/433,123, filed on Dec. 16, 2022.

(51) Int. Cl. B29C 44/56; B29C 59/02; B29L 31/00

(52) U.S. Cl. CPC B29C 44/5636; B29C 59/022; B29K 2023/06; B29L 2031/753

(57) ABSTRACT

A method of densifying an expanded polyethylene (ePE) substrate, the method comprising providing an ePE substrate having a first density and a first size, selectively densifying a portion of the ePE substrate to form a densified portion of the ePE substrate, the densified portion of the ePE substrate having a second density that is greater than the first density, the densified portion of the ePE being a densified pattern, and shrinking the ePE substrate to a second size such that the densified pattern is reduced to a fine densified pattern, the second size being smaller than the first size, the fine densified patten being smaller than the densified pattern.

### CROSS-REFERENCE TO RELATED APPLICATION

This application is a national phase application of PCT Application No. PCT/US2023/084323, internationally filed on Dec. 15, 2023, which claims the benefit of Provisional Application No. 63/433,123, filed Dec. 16, 2022, which are incorporated herein by reference in their entireties for all purposes.

### FIELD

The present disclosure relates generally to apparatuses, systems, and methods for densifying expanded polyethylene (ePE). More specifically, the disclosure relates to apparatuses, systems, and methods for densifying expanded polyethylene (ePE) that may be used in medical devices.

### BACKGROUND

Methods used for processing materials can impart specific qualities onto the processed materials. The specific qualities may be necessary for the processed material to function for its intended purpose or may allow the processed materials to be used in new ways. Selection of processing methods is important in a variety of industries, including, but not limited to the medical device industry, and more specifically for implantable medical devices. However, processed materials may be used across various industries and the same properties that are desirable in one industry may also be important in other industries.

Medical devices often need to include small features to assist in treatments or interact with small molecules in the body. For example, medical treatments may require the medical device to interact with cells in order for the treatment to be effective. In some examples, the small features may need to be within a lumen of the medical device. However, it is difficult to provide features on a small scale with precision and accuracy. What is needed are materials that can provide precise and accurate features on a small scale with reliability.

### SUMMARY

The present disclosure relates to methods, articles, and devices produced by such methods for densifying an ePE substrate, in which densifying may include fine or micro embossing. For example, articles and devices produced by such methods include densifying selective portions of the ePE substrate to create a densified pattern and then reducing the ePE substrate size to form a fine pattern, which may exhibit a desirable set of features. Such desirable features of the fine pattern may include facilitation of tissue ingrowth, thromboresistance, migration resistance, and control in direction of laminar flow.

According to one example (“Example 1”), a method of densifying an expanded polyethylene (ePE) substrate comprises optionally providing an ePE substrate having a first density and a first size, selectively densifying a portion of the ePE substrate to form a densified portion of the ePE substrate, the ePE substrate having a first density and a first size, the densified portion of the ePE substrate having a second density that is greater than the first density, the densified portion of the ePE being a densified pattern, and shrinking the ePE substrate to a second size such that the densified pattern is reduced to a fine densified pattern, the second size being smaller than the first size, the fine densified patten being smaller than the densified pattern.

According to another example (“Example 2”), further to Example 1, selectively densifying a portion of the ePE substrate is done by embossing.

According to another example (“Example 3”), further to Example 1, selectively densifying a portion of the ePE substrate further includes applying heat and pressure to the ePE substrate.

According to another example (“Example 4”), further to Example 3, applying heat and pressure to the ePE substrate includes contacting the ePE substrate with a component that is from about 110 degrees Celsius to about 180 degrees Celsius.

According to another example (“Example 5”), further to Example 1, the method further includes forming the ePE substrate into an ePE article.

According to another example (“Example 6”), further to Example 5, the ePE substrate is formed into a medical device.

According to another example (“Example 7”), further to Example 6, the medical device includes an implantable medical device.

According to another example (“Example 8”), further to Example 1, shrinking the ePE substrate to the second size further includes applying heat to the ePE substrate.

According to another example (“Example 9”), further to Example 1, a shape of the fine densified pattern is the same as a shape of the densified pattern.

According to another example (“Example 10”), further to Example 1, the fine densified pattern is configured to facilitate tissue ingrowth.

According to another example (“Example 11”), further to Example 1, the fine densified pattern is configured for thromboresistance.

According to another example (“Example 12”), further to Example 1, the fine densified pattern is configured to direct laminar flow across a surface of the fine densified pattern.

According to one example (“Example 13”), a method of creating a pattern on an expanded polyethylene (ePE) substrate comprises optionally providing an ePE substrate having a first density and a first size, applying heat and pressure to the ePE substrate using a patterned component, the ePE substrate having a first density and a first size, the patterned component selectively densifying a first portion of the ePE substrate to a second density such that the ePE substrate has a first densified pattern at the first portion of the ePE substrate, and shrinking the ePE substrate to a second size such that the first densified pattern is reduced into a second densified pattern having a set of features, the second densified pattern being smaller than the first densified pattern.

According to another example (“Example 14”), further to Example 13, the patterned component used to apply heat and pressure is a mandrel.

According to another example (“Example 15”), further to Example 14, the mandrel has a textured pattern and the first densified pattern is a corresponding textured pattern.

According to another example (“Example 16”), further to Example 13, applying heat and pressure to the ePE substrate includes contacting the ePE substrate with the patterned component that is from about 110 degrees Celsius to about 180 degrees Celsius.

According to another example (“Example 17”), further to Example 13, the first densified pattern includes a first depth ratio and the second densified pattern includes a second depth ratio, the first depth ratio and the second depth ratio being substantially the same.

According to one example (“Example 18”), an article of expanded polyethylene (ePE) comprises an ePE substrate having been formed into an ePE article, the ePE article including a fine pattern, the fine pattern being formed by selective densification patterning and shrinking process.

According to another example (“Example 19”), further to Example 18, the fine pattern is textured for thromboresistance.

According to another example (“Example 20”), further to Example 18, the fine pattern is configured to facilitate tissue ingrowth.

According to another example (“Example 21”), further to Example 18, the fine pattern is configured to direct laminar flow across a surface of the ePE article.

According to another example (“Example 22”), further to Example 18, the fine pattern is configured to facilitate tearing of the ePE article along a propagation path.

According to another example (“Example 23”), further to Example 18, the fine pattern is configured to facilitate migration resistance.

According to another example (“Example 24”), further to Example 18, the fine pattern includes a repeating shape.

According to another example (“Example 25”), further to Example 18, the fine pattern is a random pattern.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a is a block diagram of a method 100 of densifying an expanded polyethylene (ePE) substrate including a providing step, a selectively densifying step, and a shrinking step, in accordance with some embodiments;

FIG. 2A is an illustration of a front view of an embodiment in which an ePE substrate is provided at a first size, selectively densified, and shrunk to a second size, in accordance with some embodiments;

FIG. 2B is a bottom view of the illustration of FIG. 2A, in accordance with some embodiments;

FIG. 3 is a block diagram of the method of densifying the expanded polyethylene (ePE) substrate of FIG. 1 further including a forming step, in accordance with some embodiments;

FIG. 4 is an illustration of an embodiment in which the ePE substrate is formed into a tubular ePE article, in accordance with some embodiments;

FIG. 5 is a block diagram of a method of creating a pattern on an expanded polyethylene (ePE) substrate including a providing step, an applying heat and pressure step, and a shrinking step, in accordance with some embodiments;

FIG. 6 is a side-view illustration of creating a pattern on an expanded polyethylene (ePE) substrate following the method of FIG. 5, in accordance with some embodiments;

FIG. 7 is a block diagram of the method of creating the pattern on the ePE substrate of FIG. 5 further including a forming step, in accordance with some embodiments; and

FIGS. 8A and 8B are illustrations of an ePE substrate with a densified pattern, in accordance with some embodiments.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

The term “laminate” as used herein refers to multiple layers of membrane, composite material, or other materials, such as, but not limited to a polymer, such as, but not limited to an elastomer, elastomeric or non-elastomeric material, and combinations thereof.

The term “film” as used herein generically refers to one or more of the membrane, composite material, or laminate.

The term “biocompatible material” as used herein generically refers to any material with biocompatible characteristics including synthetic materials, such as, but not limited to, a biocompatible polymer, or a biological material, such as, but not limited to, bovine pericardium. Biocompatible material may comprise a first film and a second film as described herein for various embodiments.

The term “polyethylene” (PE) as used herein is inclusive of all types of polyethylene, including but not limited to, expanded polyethylene (ePE).

The term “selective densification” as used herein generally refers to densification at predetermined positions on a substrate and includes various degrees of densification including a partial densification such that the substrate maintains a porous, open microstructure after densification and a full densification in which the substrate has a closed microstructure. Selective densification may include, but it is not limited to, densification through a thickness of the substrate or along a length of the substrate.

The term “shrink” as used herein generally refers to shrinking in size such that a substrate or a pattern becomes smaller in size relative to the pre-shrunk size.

The term “reduce” as used herein generally refers to reducing a size of a substrate or a pattern such that the substrate or the pattern becomes smaller in size relative to the pre-reduced size.

### DESCRIPTION OF VARIOUS EMBODIMENTS

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

The present disclosure relates to methods, articles, and devices produced by such methods for densifying an ePE substrate, where densifying the ePE substrate may include fine or micro embossing. For example, articles and devices produced by such methods include densifying selective portions of the ePE substrate to create a densified pattern on the ePE substrate and then reducing the size of the ePE substrate to form a fine pattern, which may exhibit a desirable set of features. Such desirable features of the fine pattern may include facilitation of tissue ingrowth, thromboresistance, and control in direction of laminar flow, as well as others.

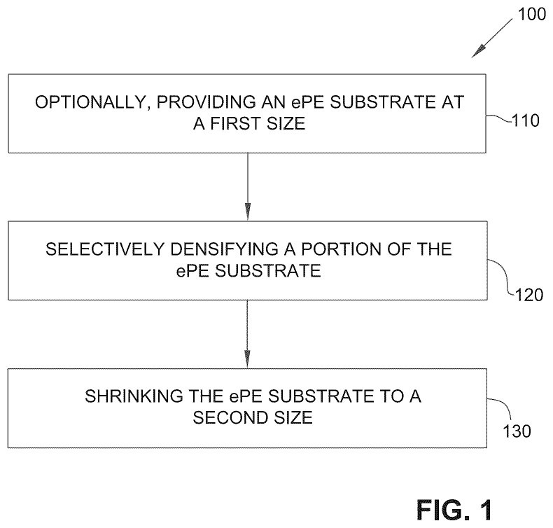

The method shown in FIG. 1 is provided as an example of the various features of the method and, although the combination of those illustrated features is clearly within the scope of invention, that example and its illustration is not meant to suggest the inventive concepts provided herein are limited from fewer features, additional features, or alternative features to one or more of those features shown in FIG. 1.

FIG. 1 is a is a block diagram of a method 100 of densifying an expanded polyethylene (ePE) substrate including a providing step, a selectively densifying step, and a shrinking step, in accordance with some embodiments. The method 100 can be implemented in a variety of contexts, including but not limited to medical devices, which may include implantable medical devices. Various forms of ePE may be implemented in the methods, including but not limited to membranes, films, tapes, tubes, and so forth. It is further understood that the ePE may be provided with various characteristics including different thicknesses, fibril and node structures, porosity, densities, and so forth. Accordingly, the embodiments discussed herein are not to be limited to specific initial conditions or forms but are understood to broadly understood to incorporate any ePE starting material that is suitable for the described methods.

In some embodiments, as shown in FIG. 1, the method of densifying an ePE substrate 100 includes optionally providing an ePE substrate at a first size 110, selectively densifying a portion of the ePE substrate 120, and shrinking the ePE substrate to a second size 130.

Further to FIG. 1, the ePE substrate also has a first density. The ePE substrate also has a first porosity. The first size may be defined by one or both of a longitudinal dimension or lateral dimension. The ePE substrate may be provided as a square, a rectangle, or other shapes and thus may include various other dimensions for determining the size of the substrate (e.g., radius, length, width, etc.).

Referring still to FIG. 1, selectively densifying the portion of the ePE substrate 120 may form a densified portion of the ePE substrate. Selective densification refers to densifying a portion the ePE substrate such that the density of a substrate that is selectively densified is increased. In some embodiments, selective densification includes increased density while also maintaining porosity in the substrate at the portion of the substrate that is selectively densified (e.g., not fully densified such that an open microstructure is retained). In some embodiments, selective densification includes increased density without retaining porosity (e.g., fully densified such that there is not an open microstructure). The portions of the substrate that are not selectively densified are porous portions defining un-densified portions. Selective densification may be done through a thickness of the ePE substrate or along a length of the ePE substrate. The densified portion of ePE may not be densified through a thickness of the ePE substrate such that at least some porosity is retained in the thickness of the ePE substrate. In some embodiments, the un-densified portions of the ePE substrate may be selectively masked such that the un-densified portions remain un-densified and porous.

The densified portion of the ePE substrate may have a second density that is greater than the first density. In some embodiments, the densified portion of the ePE substrate may have a second porosity that is less than the first porosity. The second porosity may retain porosity but have a reduction in pore size due to shrinking. The location of the shrinking and porosity may be controlled to specific locations or portions of the ePE substrate. The densified portion of the ePE substrate may be provided in a densified pattern. Selectively densifying a portion of the ePE substrate 120 may be done at a single portion of the ePE substrate or may be done at more than one portion of the ePE substrate. The densified portion may be created on the ePE substrate at any location on the ePE substrate including, but not limited to, a central portion, a left portion, or a right portion of the ePE substrate. In other embodiments, selectively densifying a portion of the ePE substrate 120 may be done at multiple portions of the ePE substrate. In some embodiments, the densified portion covers substantially all of a surface of the ePE substrate. In other embodiments, selectively densifying a portion of the ePE substrate 120 is done in one or more of a longitudinal direction, a lateral direction, or a diagonal direction relative to an axis of the ePE substrate. In some examples, the densified portion is created with a shape and a depth such that the densified pattern has a shape and depth. It is understood that any shape or pattern of densification is contemplated herein and is not limited to those provided herein, which are provided as a few examples of shapes and patterns that are possible.

In some embodiments, selectively densifying the portion of the ePE substrate 120 may be done by embossing. Embossing the portion of the ePE substrate may create the densified pattern with a portion of raised features and a portion of depressed features. In other embodiments, selectively densifying a portion of the ePE substrate 120 includes applying heat and/or pressure to the ePE substrate. Applying heat and/or pressure to the ePE substrate may include contacting the ePE substrate with a component. The component may be heated to a temperature between around the glass transition temperature or melt temperature of the ePE substrate which may be between about 110° C. to about 180° C. For example, the component may be heated to a temperature of from about 110° C. to about 120° C., from about 120° C. to about 130° C., from about 130° C. to about 140° C., from about 140° C. to about 150° C., from about 150° C. to about 160° C., from about 160° C. to about 170° C., or from about 170° C. to about 180° C. The component may be provided at any temperature appropriate to create the densified pattern. The component may be applied at a pressure of above about 2 PSI. The pressure applied should be such that the ePE substrate is not splayed or ruptured. The component may contact the ePE substrate at any pressure appropriate to create the densified pattern. In some embodiments, the heat and/or pressure may be applied to the ePE substrate at a constant value. In other embodiments, the heat and/or pressure may be applied to the ePE substrate at a changing value. The temperature and/or pressure selected may impact the shape and the depth of the densified pattern.

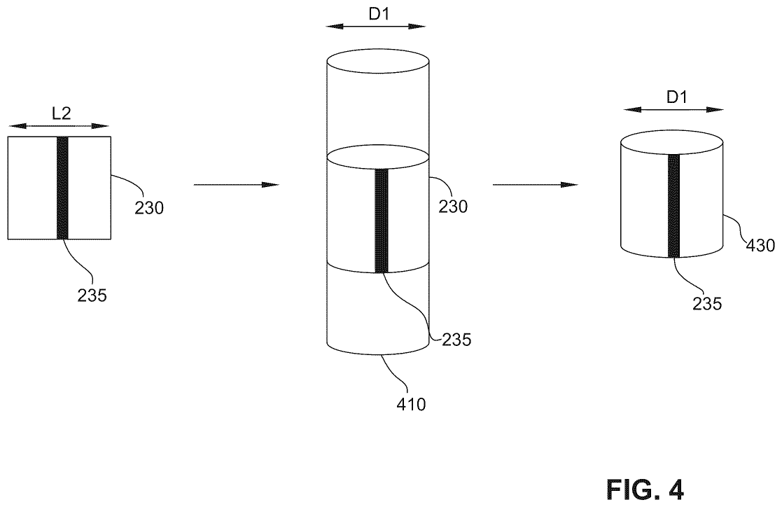

In some embodiments, embossing may occur via manual embossing or automatic embossing. The embossing may occur via an external device (not shown; e.g., a soldering iron, heated stamp, etc.). The embossing may occur via an internal device (not shown; a heated mandrel, etc.). Embossing via the external device may selectively densify an outer surface portion of the ePE substrate. Embossing via the internal device may selectively densify an inner surface portion of the ePE substrate (e.g., an inner lumen of a tubular construct ePE article 430 of FIG. 4).

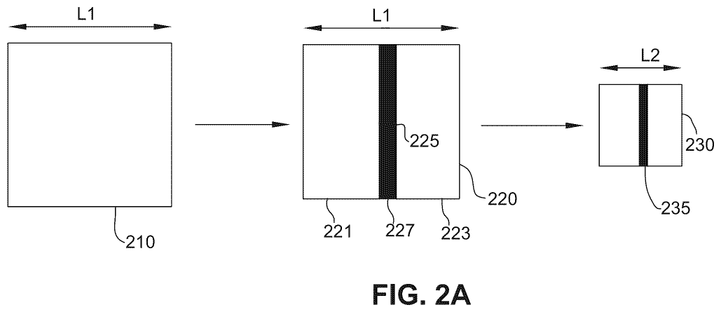

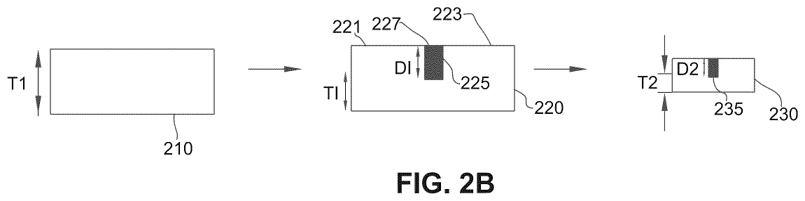

Referring still to FIG. 1, in some embodiments, after selectively densifying a portion of the ePE substrate 120, such as a central portion 227 (see FIG. 2A) of the ePE substrate, the ePE substrate is shrunk from a first size to a second size 130, the second size being smaller than the first size. In some embodiments, shrinking the ePE substrate to the second size 130 is done such that the densified pattern is reduced in size, or shrunk, to form a fine densified pattern. The fine densified pattern may be smaller in size than the initial densified pattern. In some embodiments, the ability to retain porosity in the ePE substrate after selective densification facilitates shrinking of the ePE substrate, including the densified and un-densified portions of the ePE substrate. In these embodiments, the densified and un-densified portions of the ePE substrates shrink in different proportions. For example, the un-densified portion may shrink proportionally more than the selectively densified portions. For example, proportional shrinking may occur by providing an ePE substrate that has fibrils oriented in a direction (e.g., substantially aligned in a specific direction) such that the ePE substrate is prone to shrinking proportionally more in a direction perpendicular to the fibrils. In some embodiments, selectively densifying portions of the ePE substrate allows the ePE substrate to selectively shrink at the un-densified portions. Shrinking may occur at the un-densified portions of the ePE substate that retained porosity after selective densification. Shrinking may also occur throughout the thickness of the densified portions of the ePE substrate such that porosity is retained at a portion of the thickness. In some embodiments, the ePE substrate is fully densified upon shrinking. In other embodiments, the ePE substrate may retain porosity upon shrinking.

In some embodiments, the fine densified pattern has the same or substantially similar shape as the densified pattern. For example, if the shape of the densified pattern is a longitudinal rectangle, the fine densified pattern would retain the shape as the longitudinal rectangle (see e.g., FIGS. 2A-2B). In this regard, the fine densified pattern may retain dimensional accuracy in shape upon being reduced in size. In other embodiments, the fine densified pattern is a different shape than the densified pattern. In still other embodiments, the fine densified pattern may be a distorted shape from that of the densified pattern. In some embodiments, the fine densified pattern includes a depth. In some embodiments, the depth of the fine densified pattern may be the same as the depth of the densified pattern. In other embodiments, a ratio of the depth of the densified pattern relative to a longitudinal axis of the ePE substrate is the same as a ratio of the depth of the fine densified pattern relative to a longitudinal axis of the smaller densified ePE substrate. In this regard, the fine densified pattern may also retain dimensional accuracy in depth upon being reduced in size. In still other embodiments, a relative surface area coverage of the densified pattern on the densified ePE substrate may be the same as a relative surface area coverage of the fine densified pattern on the smaller densified ePE substrate. In some embodiments, the densified pattern is shrunk to the fine densified pattern during shrinking of the ePE substrate such that the densified pattern shrinks proportionally with the ePE substrate.

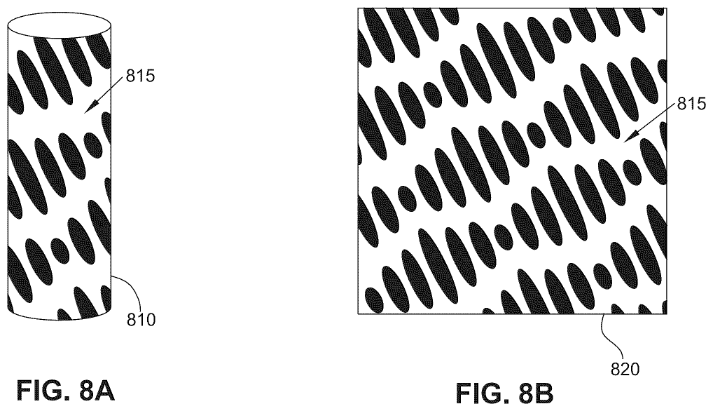

In some embodiments, the fine densified pattern imparts a set of features onto the ePE substrate. In some embodiments, the fine densified pattern is configured to facilitate tissue ingrowth. In some embodiments, the fine densified pattern is configured for thromboresistance. In some embodiments, the fine densified pattern is configured to direct laminar flow across a surface of the fine densified pattern. Further examples of the set of features are included with respect to FIGS. 8A-8B.

In some embodiments, shrinking the densified ePE substrate to the second size 130 further includes applying heat to the densified ePE substrate. The densified ePE substrate may be heated to a temperature around the glass transition temperature or melt temperature of the densified ePE substrate which may be between about 110° C. to about 180° C. For example, densified ePE substrate may be heated to a temperature of from about 110° C. to about 120° C., from about 120° C. to about 130° C., from about 130° C. to about 140° C., from about 140° C. to about 150° C., from about 150° C. to about 160° C., from about 160° C. to about 170° C., or from about 170° C. to about 180° C. In some embodiments, the ePE substrate has heat applied by a heated environment (e.g., an oven). In some embodiments, applying heat to the ePE substrate selectively densifies the ePE substrate. In some embodiments, the application of heat may cause the ePE substrate to naturally shrink or retract. The degree of shrinking or retraction may match the degree of expansion of the ePE substrate. In some embodiments, shrinking the densified ePE substrate to the second size 130 is done when the densified ePE substrate is unconstrained. In other embodiments, shrinking the densified ePE substrate to the second size 130 may be done when the densified ePE substrate is constrained in at least one dimension (e.g., longitudinally, laterally, etc.). For example, the ePE substrate may be constrained in the z-direction (e.g., a thickness direction) such that the ePE substrate may flow longitudinally and laterally when heat is applied. Constraining in the z-direction may include positioning the ePE substrate between two plates (e.g., weighted plates) with shims between the two plates at the same thickness as the ePE substrate to constrain the z-direction of the ePE substrate.

In some embodiments, the densified ePE substrate is cooled after having been subjected to heat. The densified ePE substrate may be cooled at room temperature, may be placed in an environment that is cooler than room temperature (e.g., a freezer), or may be slowly cooled in an environment with a temperature higher than room temperature. In some embodiments, the environment in which the densified ePE substrate is cooled may be at a stable temperature or may be a variable temperature. In some embodiments, the variable temperature of the environment allows the densified ePE substrate to be cooled at a controlled rate. The rate of cooling of the densified ePE substrate may be constant or may be variable.

FIG. 2A is an illustration of a front view of an embodiment in which an ePE substrate 210 is provided at a first size L1, selectively densified, and then shrunk to a second size L2, in accordance with some embodiments. In some embodiments, the example in FIG. 2A follows the method 100 of FIG. 1 as described above.

In FIG. 2A, the ePE substrate 210 is provided with the first size L1. In some embodiments, this may follow the method step of providing the ePE substrate at the first size 110 of FIG. 1. In this embodiment, the first size L1 is defined in the horizonal direction (e.g., width), but the first size can also be defined by the longitudinal direction (e.g., height), the thickness direction (e.g., thickness), or a combination of any of the lateral direction, the longitudinal direction, and the thickness direction. In this embodiment, the ePE substrate 210 is shown as a square, but other shapes of the ePE substrate 210 are contemplated.

Further to FIG. 2A, a portion of the ePE substrate 210 may be selectively densified such that an ePE substrate with a densified portion 220 is formed. In some embodiments, forming the ePE substrate with the densified portion 220 be may substantially similar to the method step of selectively densifying the portion of the ePE substrate 120 as described in FIG. 1. The ePE substrate with a densified portion 220 includes a densified pattern 225 and the densified pattern 225 has a shape. In this embodiment, the densified pattern 225 has a longitudinal rectangle as the shape. Other shapes of the densified pattern 225 may include, but are not limited to, rounded shapes, square shapes, or triangular shapes, and so forth. The shape may also extend in a lateral direction, in a diagonal direction, or in any other direction. In this embodiment, the densified pattern 225 is defined at a central portion 227 of the ePE substrate with the densified portion 220. In other embodiments, the densified pattern 225 may also be created at a left portion 221 of the ePE substrate with a densified portion 220 or a right portion 223 of the ePE substrate with the densified portion 220, or at any location between the left portion 221 and the right portion 223. In this embodiment, one portion of the ePE substrate with a densified portion 220 has a densified pattern 225, but in other embodiments, multiple densified patterns can be created within a surface of ePE substrate with the densified portion 220. In this embodiment, the ePE substrate with a densified portion 220 may shrink to an intermediate size LI. The intermediate size LI may be smaller than the first size L1. This change in size may occur due to localized changes in a depth of the ePE substrate with a densified portion 220 from the creation of densified pattern 225, as shown in FIG. 2B. In other embodiments, the intermediate size LI may be the same as the first size L1.

Further to FIG. 2A, the ePE substrate with a densified portion 220 may be reduced to a retracted ePE substrate 230. The retracted ePE substrate 230 has a second size L2. In some embodiments, this may follow the method step of shrinking the ePE substrate to the second size 130 of FIG. 1. In this embodiment, the second size L2 is smaller than the first size L1. In this embodiment, the second size L2 is also smaller than the intermediate size LI. The retracted ePE substrate 230 includes a fine densified pattern 235. In some embodiments, the fine densified pattern 235 is reduced in size from the densified pattern 225. In this embodiment, the fine densified pattern 235 is created from the densified pattern 225 and the fine densified pattern 235 results from shrinking the ePE substrate with the densified portion 220. In this embodiment, the fine densified pattern 235 retains the shape of the densified pattern 225. In this embodiment, the fine densified pattern 235 also retains the same relative surface area coverage as the densified pattern 225 relative to the un-densified regions of the ePE substrate 220. In other embodiments, it is contemplated that the fine densified pattern 225 has a slightly different shape or a slightly different surface area coverage than the densified pattern 225. In some embodiments, it is contemplated that the fine densified pattern 235 is modified from the densified pattern 225. For example, the densified pattern 225 may be substantially square in shape and the fine densified pattern 235 may be substantially rectangular in shape. Other shapes such as a substantially circular densified pattern 225 to a substantially oval fine densified pattern 235 is also contemplated. The change in shape may occur to do constraining shrinking in a direction or may occur by providing an ePE substrate that has fibrils oriented in a direction (e.g., substantially aligned in a specific direction) such that the ePE substrate is prone to shrinking proportionally more in a direction perpendicular to the fibrils.

FIG. 2B is a bottom view of the illustration of FIG. 2A, in accordance with some embodiments. The ePE substrate 210 is shown with a first thickness T1. The ePE substrate with the densified portion 220 is shown with an intermediate thickness TI and the densified pattern 225. In some embodiments, the densified pattern 225 may have a depressed depth D1 that projects downwardly relative to the un-densified portions (e.g., the left portion 221 and the right portion 223). This may be such that the intermediate thickness TI is smaller than the first thickness T1 in the location of the densified pattern 225. In some embodiments, the depressed depth D1 is less than a thickness of the ePE substrate with the densified portion 220 such that a portion of the thickness retains porosity. In this embodiment, when the densified pattern 225 has a depressed depth, the fine densified pattern 235 may have a depressed depth D2. In some embodiments, the depressed depth D2 may be the same as the depressed depth D1. In other embodiments, the depressed depth D2 may further recess downwardly such that the depressed depth D2 is larger than the depressed depth D1. In further embodiments, the depressed depth D2 may retract such that the depressed depth D2 is smaller than depressed depth D1. In this further embodiment, the un-densified portions (e.g., the left portion 221 and the right portion 223) may be operable to retract to a higher degree than the densified portion (e.g., central portion 227) due to higher porosity at the un-densified portions. The higher porosity of the un-densified portions may be operable to at least partially contract upon shrinking.

In other embodiments, the densified pattern 225 may protrude or project outwardly relative to the un-densified portions (e.g., the left portion 221 and the right portion 223). This may be achieved by forming the densified pattern 225 as previously described and subsequently masking the densified pattern 225 on the densified portion 220 of the ePE substrate 210. This may be used, for example, on angioplasty balloons such that the balloon has a protruding densified pattern 225 to grip a vessel upon implantation.

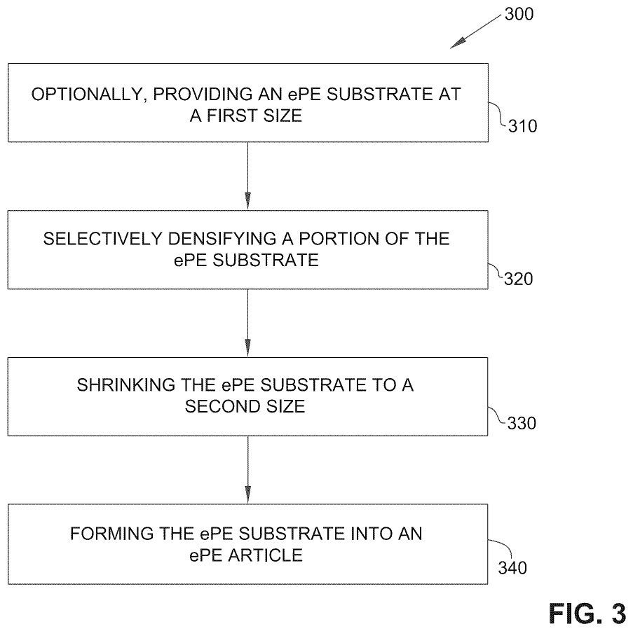

FIG. 3 is a block diagram of the method 300 of densifying the expanded polyethylene (ePE) substrate of FIG. 1 further including a forming step, in accordance with some embodiments. This method 300 can be implemented in a variety of contexts, including but not limited to medical devices, which may include implantable medical devices. The method 300 includes a plurality of method steps including optionally providing an ePE substrate at a first size 310, selectively densifying a portion of the ePE substrate 320, shrinking the ePE substrate to a second size 330, and forming the ePE substrate into an ePE article 340.

The method step of optionally providing an ePE substrate at a first size 310 may be substantially similar to the providing an ePE substrate at a first size 110 as described above with respect to FIG. 1. The method step of selectively densifying a portion of the ePE substrate 320 may be substantially similar to the selectively densifying a portion of the ePE substrate 120 as described above with respect to FIG. 1. The method step of shrinking the ePE substrate to a second size 330 may be substantially similar to the shrinking the ePE substrate to a second size 130 as described above with respect to FIG. 1.

In forming the ePE substrate into an ePE article 340, an ePE article may include, but is not limited to, a tubular construct or a flat construct. The ePE article may be formed into or provided as a medical device or a component of a medical device. The medical device may include an implantable medical device. The medical device may be used for long-term implantation or for short-term implantation (e.g., temporary implantation). The tubular construct may be implemented, for example, as a graft. The flat construct may be implemented, for example, as a hernia patch, a cardiovascular patch, a neuro membrane, and so forth. The medical device may further include a balloon (e.g., an angioplasty balloon, a urinary tract balloon, a stent deployment balloon) formed with a fine densified pattern where the fine densified pattern facilitates anchoring of the balloon to tissue of a patient to substantially keep the balloon in place and prevent migration of the device. In some embodiments, forming the ePE substrate into an ePE article 340 may be done prior to the step of selectively densifying the portion of the ePE substrate 320 such that the ePE article is selectively densified. In some embodiments, forming the ePE substrate into an ePE article 340 may be done after the selective densification step but prior to shrinking the ePE substrate to a second size 330 such that the ePE article is shrunk to the second size. In other embodiments, forming the ePE substrate into an ePE article 340 may be done after shrinking the ePE substrate to a second size 330 such the ePE article is formed at the second size.

FIG. 4 is an illustration of an embodiment in which the reduced ePE substrate 230 is formed into a tubular construct ePE article 330, in accordance with some embodiments. This illustration is further to the embodiment of FIGS. 2A and 2B. Forming the reduced ePE substrate 230 into the tubular construct ePE article 430 may further include wrapping the reduced ePE substrate 230 around a mandrel 410. The mandrel 410 may have a diameter D1. When wrapped around the mandrel 410, the reduced ePE substrate 230 may be bonded or coupled to itself through one of melt bonding, bonding using an adhesive, or mechanical attachment (i.e., using a suture) to form the tubular construct ePE article 430. In this embodiment, the smaller densified ePE substrate 235 is wrapped around the mandrel 410 such that the fine densified pattern is in a vertical orientation. In other embodiments, the smaller densified ePE substrate 235 is wrapped around the mandrel 410 such that the fine densified pattern 235 is in a lateral orientation. The tubular construct ePE article 430 may be a medical device including, but not limited to, an implantable graft.

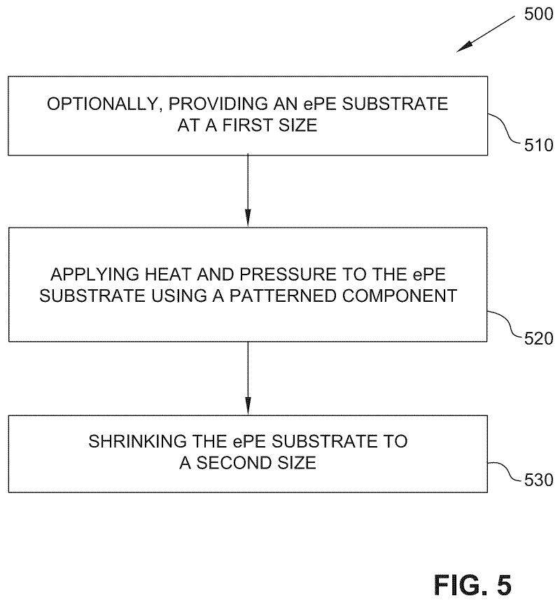

FIG. 5 is a is a block diagram of a method 500 of creating a pattern on an expanded polyethylene (ePE) substrate including a providing step, an applying heat and pressure step, and a shrinking step, in accordance with some embodiments. The method 500 can be implemented in a variety of contexts, including but not limited to medical devices, which may include implantable medical devices.

In some embodiments, as shown in FIG. 5, the method of creating the pattern on an ePE substrate 500 includes optionally providing an ePE substrate at a first size 510, applying heat and pressure to the ePE substrate using a patterned component 520, and shrinking the ePE substrate to a second size 530.

Further to FIG. 5, in optionally providing the ePE substrate at the first size 510, the ePE substrate also has a first density. The ePE substrate also has a first porosity. The first size may be defined by one or both of a longitudinal dimension or lateral dimension. The ePE substrate may be provided as a square, a rectangle, or other shapes.

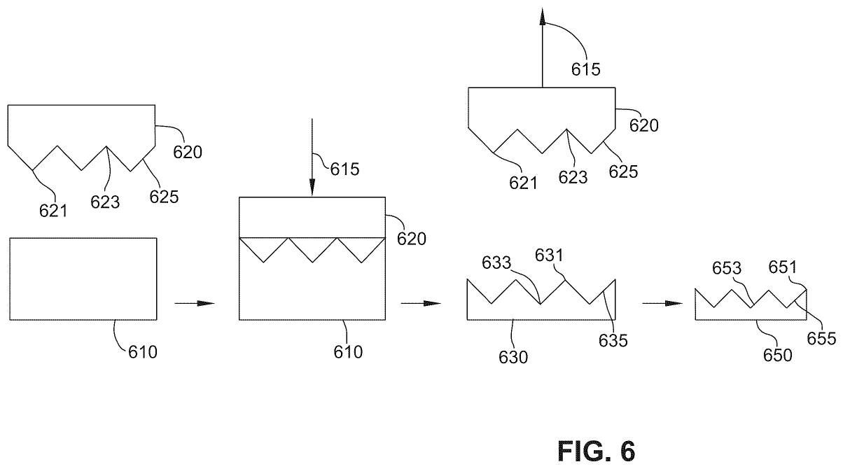

Referring still to FIG. 5, applying heat and pressure to the ePE substrate using the patterned component 520 may be such that the patterned component selectively densifies the ePE substrate. The selective densification may be defined substantially similarly as described with respect to FIG. 1. The heat and pressure may influence the degree to which the ePE substrate is densified (e.g., through a thickness of the ePE substrate) and the pattern of the patterned component may include the location of densification (e.g., across a length of the ePE substrate). The patterned component may selectively densify a first portion of the ePE substrate to a second density such that the ePE substrate has a first densified pattern at the first portion of the ePE substrate. In some embodiments, the second density may be greater than the first density. In some embodiments, the patterned component used to apply heat and pressure is a mandrel. In some embodiments, wherein the patterned component is a mandrel, the mandrel may have a textured pattern and the first densified pattern is a corresponding textured pattern, (e.g., as shown in FIG. 6).

In some embodiments, applying heat and pressure to the ePE substrate with a patterned component 520 further includes contacting the ePE substrate with the patterned component at a temperature around the glass transition temperature or melt temperature of the densified ePE substrate which may be between about 110° C. to about 180° C. For example, densified ePE substrate may be heated to a temperature of from about 110° C. to about 120° C., from about 120° C. to about 130° C., from about 130° C. to about 140° C., from about 140° C. to about 150° C., from about 150° C. to about 160° C., from about 160° C. to about 170° C., or from about 170° C. to about 180° C. The component may be provided at any temperature appropriate to create the first densified pattern. The patterned component may be applied at a pressure above about 2 PSI. The pressure applied should be such that the ePE substrate is not splayed or ruptured. The patterned component may be provided at any pressure appropriate to create the first densified pattern. In some embodiments, the heat and pressure may be applied to the ePE substrate at a constant value. In other embodiments, the heat and pressure may be applied to the ePE substrate at a variable value to create the first densified pattern.

In applying heat and pressure to the ePE substrate using the patterned component 520, a microstructure of the ePE substrate may be modified. For example, the microstructure of the ePE substrate may include a node and fibril structure, which may define a porous (e.g., microporous) structure. In some embodiments, the microstructure porosity may be reduced upon applying heat and pressure to the ePE substrate using the patterned component 520 while retaining some porosity and node and fibril microstructure. In some embodiments, the microstructure density may be substantially unchanged upon applying heat and pressure to the ePE substrate using the patterned component 520. In some embodiments, the application of heat and pressure may result in an at least partially densified microstructure such that at least portions of the node and fibril microstructure is densified and no longer defines a porous microstructure. In other embodiments, the ePE substrate may be fully densified such that the microstructure is fully densified.

Referring still to FIG. 5, in some embodiments, shrinking the ePE substrate to the second size 530 to is done after applying heat and pressure to the ePE substrate using the patterned component 520. In some embodiments, shrinking the ePE substrate to the second size 530 is done such that the first densified pattern is reduced or shrunk in size into a second densified pattern having a set of features, the second densified pattern being smaller in size than the first densified pattern. In some embodiments, the microstructure of the ePE substrate experiences a reduction in a number of open spaces upon shrinking the ePE substrate to the second size 530. In some embodiments, the second densified pattern has the same shape as the first densified pattern. In this regard, the second densified pattern substantially retains dimensional accuracy in shape upon shrinking in size. In other embodiments, the second densified pattern is a slightly different shape than the first densified pattern. In still other embodiments, the second densified pattern may be a modified shape from that of the first densified pattern. In some embodiments, the first densified pattern includes a depth. The depth may be a depressed depth (e.g., projecting inwardly from the axis of the ePE substrate). The second densified pattern may retain the same depth as the first densified pattern upon shrinking. However, a magnitude of the depth of the first densified pattern may differ from a magnitude of depth of the second densified pattern. Instead, the depth of the second densified pattern may retain a depth second ratio with respect to the axis of the ePE substrate, the second depth ratio being substantially the same as a first depth ratio of the first densified pattern with respect to the axis of the ePE substrate. In this regard, the second densified pattern retains dimensional accuracy in depth upon shrinking in size. Further, the first densified pattern covers a first surface area of the ePE substrate. The second densified pattern may retain the same surface area coverage as the first densified pattern. Said differently, a surface area ratio between a set of densified portions of the ePE substrate and a set of un-densified portions of the ePE substrate may be the same in the second densified pattern as the first densified pattern.

FIG. 6 is a side-view illustration of creating a pattern on an ePE substrate 610 following the method of FIG. 5, in accordance with some embodiments. In FIG. 6, the ePE substrate 610 is provided in alignment with a patterned component 620. The patterned component 620 includes a pattern 625. In this embodiment, the pattern is a triangular pattern 625 with raised areas 621 and depressed areas 623. However, other shapes for the pattern 625 are contemplated including, but not limited to, rounded patterns, square patterns, rectangular patterns, and so forth.

Further to FIG. 6, in this embodiment, the ePE substrate 610 is shown in contact with the patterned component 620. When applying a heat and pressure force 615 to the patterned component 620 such that it contacts the ePE substrate 610, the ePE substrate 610 is compressed. In some embodiments, the ePE substrate 610 becomes a densified ePE substrate 630. In some embodiments, the ePE substrate 610 is compliant such that when the heat and pressure force 615 is removed, the densified ePE substrate 630 retains a first densified pattern 635. In this regard, the patterned component 620 is operable to create the first densified pattern 635. In some embodiments, the first densified pattern 635 may correspond to the pattern 625 of the patterned component 620. In some embodiments, the first densified pattern 635 is a mirror image of the pattern 625 of the patterned component 620. In this embodiment, the first densified pattern 635 has first raised areas 631 and first depressed areas 633 that correspond to the raised areas 621 and depressed areas 623 of the pattern 625.

Further to FIG. 6, in some embodiments, after the densified ePE substrate 630 with the first densified pattern 635 is created, the densified ePE substrate 630 is shrunk down in size to a smaller densified ePE substrate 650. In some embodiments, the smaller densified ePE substrate 650 includes a second densified pattern 655. In some embodiments, the dimensions of the first densified pattern 635 are reduced to the second densified pattern 655. The second densified pattern 655 may retain the same shape or features as the first densified pattern 635. In this embodiment, the second densified pattern 655 includes second raised areas 651 and second depressed areas 653, which correspond to the first raised areas 631 and the first depressed areas 633 but are smaller in size. Further, the second densified pattern 655 has substantially the same depth ratio as the first densified pattern 635. The second densified pattern 655 also retains the same relative surface area coverage ratio as the first densified pattern 635. In this regard, the second densified pattern 655 maintains dimensional accuracy both in depth and shape upon shrinking of the densified ePE substrate.

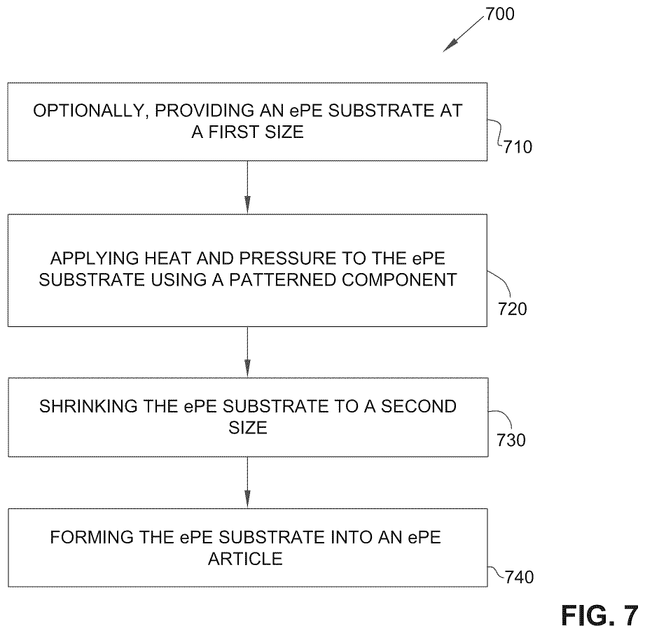

FIG. 7 is a block diagram of the method 700 of creating the pattern on the ePE substrate of FIG. 5 further including a forming step, in accordance with some embodiments. This method 700 can be implemented in a variety of contexts, including but not limited to medical devices, which may include implantable medical devices.

The method 700 includes optionally providing an ePE substrate at a first size 710, applying heat and pressure to the ePE substrate using a patterned component 720, shrinking the ePE substrate to a second size 730, and forming the ePE substrate into an ePE article 740.

In some embodiments, the method step of optionally providing an ePE substrate at a first size 710 may be substantially similar to optionally providing an ePE substrate at a first size 510 as described above with respect to FIG. 5. In some embodiments, the method step of applying heat and pressure to the ePE substrate using the patterned component 720 may be substantially similar to the applying heat and pressure to the ePE substrate using the patterned component 520 as described above with respect to FIG. 5. In some embodiments, the method step of shrinking the ePE substrate to the second size 730 may be substantially similar to the shrinking the ePE substrate to the second size 530 as described above with respect to FIG. 5.

Further to FIG. 7, in forming the ePE substrate into the ePE article 740, an ePE article may include, but is not limited to, a tubular construct or a flat construct. The ePE article may be formed into or provided as a medical device or a component of a medical device. The medical device or component of the medical device may be used for long-term implantation or for short-term implantation. The medical device may include an implantable medical device. The tubular construct may be implemented, for example, as a graft. The flat construct may be implemented, for example, as a hernia patch, a cardiovascular patch, a neuro membrane, and so forth. The medical device may further include a balloon (e.g., e.g., an angioplasty balloon, a urinary tract balloon, a stent deployment balloon) formed with a fine densified pattern where the fine densified pattern facilitates anchoring of the balloon to tissue of a patient to substantially keep the balloon in place. In some embodiments, forming the ePE substrate into an ePE article 740 may be done prior to applying heat and pressure to the ePE substrate using the patterned component 720 such that a portion of the ePE article is densified. In some embodiments, forming the ePE substrate into an ePE article 740 may be done after the application of heat and pressure step but prior to shrinking the ePE substrate to a second size 730 such that the ePE article is shrunk to the second size. In other embodiments, forming the ePE substrate into an ePE article 740 may be done after shrinking the ePE substrate to a second size 730 such the ePE article is formed at the second size. In some embodiments, forming the ePE substrate into an ePE article 740 is substantially similar to forming the ePE substrate into an ePE article 340 of FIG. 3. In some embodiments, the tubular article may be formed from the densified ePE substrate using a mandrel, similar to the illustration of FIG. 4.

FIGS. 8A and 8B are illustrations of an ePE article 810, 820 with a densified pattern 815, in accordance with some embodiments. FIG. 8A illustrates an ePE tubular article 810 and FIG. 8B illustrates an ePE flat article 820. Both the ePE tubular article 810 and the ePE flat article 820 includes a fine pattern 815. The pattern 815 may function substantially similar to the fine densified pattern 235 of FIGS. 2A, 2B, and 4 and/or substantially similar to the second densified pattern 655 of FIGS. 6 and 8. In this embodiment, the fine pattern 815 is a densified pattern that has been shrunk to a reduced size.

In some embodiments, the ePE tubular article 810 and the ePE flat article 820 were made with a starting ePE substrate, may be similar to the ePE substrates 210 (FIGS. 2A and 2B) or the ePE substrate 610 (FIG. 610). The starting ePE material was formed into the ePE article, which may include the ePE tubular article 810 and the ePE flat article 820. The ePE article includes the fine pattern 815. The fine pattern 815 may be formed by a selective densification patterning and shrinking process, which may be substantially similar to one of the methods described in FIGS. 1, 3, 5, and/or 7.

In this embodiment, the fine pattern 815 is a rounded pattern or a pattern of repeated rounded shapes. In other embodiments, the fine pattern 815 may have a different shape including, but not limited to, a square shape, a triangular shape, or a rectangular shape. In some embodiments, the fine pattern 815 is a repeating pattern. In some embodiments, the fine pattern 815 is a textured pattern. The textured pattern may include changes in depth where the changes in depth include localized raised areas and localized depressed areas.

The fine pattern 815 may impart a set of features onto the ePE tubular article 810 and/or the ePE flat article 820. In some embodiments, the fine pattern 815 is textured for thromboresistance. In some embodiments, an outer portion of the ePE article 810, 820 is textured. In some embodiments, an inner portion of the ePE article 810, 820 is textured. In some embodiments, when the ePE article is the ePE tubular article 810, an inner surface of a lumen of the ePE tubular article 810 may be textured for thromboresistance. In some embodiments, the texture of the fine pattern 815 can attract cells for ingrowth. In some embodiments, the texture of the fine pattern 815 can discourage growth or ingrowth on the ePE article 810, 820 (e.g., thrombus growth).

In some embodiments, the fine pattern 815 is a textured surface that is configured to reduce friction and surface tension for better bonding. In some embodiments, the combination of a textured surface and retained porosity results in improved adhesion to another surface or to another device.

In some embodiments, the fine pattern 815 is configured to facilitate tissue ingrowth. In some embodiments, this may be accomplished by creating increased surface area on the surface of the ePE article 810, 820. In some embodiments, the increased surface area is facilitated the textured surface, or fine pattern 815.

In some embodiments, the fine pattern 815 is configured to improve strength along a z-axis (e.g., along a thickness) of the ePE article 810, 820. This may be accomplished through the selective densification of the ePE article 810, 820 and shrinking the ePE article 810, 820 to create the fine pattern 815. This may be improved through constraining the z-axis during processing. The improved strength in the z-axis may also allow for more than one ePE article (e.g., articles 810, 820) to be linked together through at least one of collapsing and bonding.

In some embodiments, the fine pattern 815 is configured to resist creep of the ePE article 810, 820.

In some embodiments, the fine pattern 815 is configured to direct laminar flow across a surface of the ePE article 810, 820. Directing laminar flow may include directing of cells, fluids, or other materials within the body. In some embodiments, this includes facilitating flow for thromboresistance. This, in turn, may also facilitate improved abrasion and wear-resistance. The direction of laminar flow may allow the ePE article 810, 820 to be configured as anti-microbial. Directing laminar flow may be across the surface of the ePE article 810, 820 in any direction. Directing laminar flow may also be through the ePE article 810, 820, such as through the lumen of the ePE tubular article 910.

In some embodiments, the fine pattern 815 is configured to facilitate tearing of the ePE article 810, 820 along a propagation path. In some embodiments, the portions of the ePE article with the fine pattern 815 may be tear resistant. The portions of the ePE article without the fine pattern 815 may not be tear resistant such that when a force is applied, the portions of the ePE article without the fine pattern 815 tear. The portions of the ePE article without the fine pattern 815 may be selected such that a propagation path is formed for the tear to propagate through or across the ePE article. By providing the tear resistant fine pattern 815, the ePE article 810, 820 may be selectively torn along the propagation path, which may be a pre-determined shape. This feature may allow for more precise control over the tearing locations of the ePE article 810, 820. Facilitation of tearing may also be used in devices in which fenestrations are formed. For example, the use of the fine pattern 815 may allow the ePE article to tear selectively upon introduction of a suture. Portions of the ePE article surrounding a suture location may be tear resistant such that the suture is retained in the place and the fenestration created by the suture cannot propagate (e.g., acts as an integral grommet).

In some embodiments, the ePE article 810, 820 is capable of distention in a horizontal, lateral, or radial direction. The ability to distend may come from shrinking the ePE substrate such that a stored length is formed. The ability to distend may also allow for changes in the horizontal, lateral, or radial direction without adding additional mass or material to the ePE article 810, 820.

In some embodiments, the fine pattern 815 is a regular pattern. The regular pattern may be a repeating shape or a repeating series of shapes. In other embodiments, the fine pattern 815 is an irregular pattern. The irregular pattern may not have a repeating shape or may be a random pattern.

In some embodiments, the fine pattern 815 can provide a unique feel or texture. In some embodiments, the fine pattern 815, can improve wickability of moisture. In some embodiments, the fine pattern 815 can provide an anti-microbial surface. These features may be found in embodiments related to fabrics.

In some embodiments, the fine pattern 815 is useful in preventing device migration. In long-term implants (e.g., stent-grafts) texture from the fine pattern 815 can increase the force necessary to displace the long-term implant while also providing an enhanced tissue attachment surface. In temporary implants (e.g., angioplasty or urinary tract balloons) the texture from the fine densified pattern 815 may be useful in stabilizing the temporary implant, while also inhibiting tissue attachment to facilitate eventual device removal.

Although specific embodiments are provided herein, it is understood that different arrangements and material properties may be selected and be treated in the spirit of this disclosure. Furthermore, the specific embodiments provide temperatures, steps, and properties that may be modified while still being within the spirit of this disclosure.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

1. A method of densifying an expanded polyethylene (ePE) substrate, the method comprising:
selectively densifying a portion of an ePE substrate to form a densified portion of the ePE substrate, the ePE substrate having a first density and a first size, the densified portion of the ePE substrate having a second density that is greater than the first density, the densified portion of the ePE having a densified pattern; and
shrinking the ePE substrate to a second size such that the densified pattern is reduced to a fine densified pattern, the second size being smaller than the first size, the fine densified patten being smaller than the densified pattern.

2. The method of claim 1, wherein selectively densifying a portion of the ePE substrate is done by embossing.

3. The method of claim 1, wherein selectively densifying a portion of the ePE substrate further includes applying heat and pressure to the ePE substrate.

4. The method of claim 3, wherein applying heat and pressure to the ePE substrate includes contacting the ePE substrate with a component that is from about 110 degrees Celsius to about 180 degrees Celsius.

5. The method of claim 1, further including forming the ePE substrate into an ePE article.

6. The method of claim 5, wherein the ePE substrate is formed into a medical device.

7. The method of claim 6, wherein the medical device includes an implantable medical device.

8. The method of claim 1, wherein shrinking the ePE substrate to the second size further includes applying heat to the ePE substrate.

9. The method of claim 1, wherein a shape of the fine densified pattern is the same as a shape of the densified pattern.

10. The method of claim 1, wherein the fine densified pattern is configured to facilitate tissue ingrowth.

11. The method of claim 1, wherein the fine densified pattern is configured for thromboresistance.

12. The method of claim 1, wherein the fine densified pattern is configured to direct laminar flow across a surface of the fine densified pattern.

13. A method of creating a pattern on an expanded polyethylene (ePE) substrate, the method comprising:
applying heat and pressure to an ePE substrate using a patterned component, the ePE substrate having a first density and a first size, the patterned component selectively densifying a first portion of the ePE substrate to a second density such that the ePE substrate has a first densified pattern at the first portion of the ePE substrate;
shrinking the ePE substrate to a second size such that the first densified pattern is reduced into a second densified pattern having a set of features, the second densified pattern being smaller than the first densified pattern.

14. The method of claim 13, wherein the patterned component used to apply heat and pressure is a mandrel.

15. The method of claim 14, wherein the mandrel has a textured pattern and the first densified pattern is a corresponding textured pattern.

16. The method of claim 13, wherein applying heat and pressure to the ePE substrate includes contacting the ePE substrate with the patterned component that is from about 110 degrees Celsius to about 180 degrees Celsius.

17. The method of claim 13, wherein the first densified pattern includes a first depth ratio and the second densified pattern includes a second depth ratio, the first depth ratio and the second depth ratio being substantially the same.

18. An article of expanded polyethylene (ePE) comprising:
an ePE substrate having been formed into an ePE article, the ePE article including a fine pattern, the fine pattern being formed by selective densification patterning and shrinking process.

19. The article of claim 18, wherein the fine pattern is textured for thromboresistance.

20. The article of claim 18, wherein the fine pattern is configured to facilitate tissue ingrowth.

21. The article of claim 18, wherein the fine pattern is configured to direct laminar flow across a surface of the ePE article.

22. The article of claim 18, wherein the fine pattern is configured to facilitate tearing of the ePE article along a propagation path.

23. The article of claim 18, wherein the fine pattern is configured to facilitate migration resistance.

24. The article of claim 18, wherein the fine pattern includes a repeating shape.

25. The article of claim 18, wherein the fine pattern is a random pattern.
